(19) United States
(12) Patent Application Publication
(10) Pub. No.: US 2025/0157343 A1
(43) Pub. Date: May 15, 2025

(54) METHOD AND DEVICE FOR SETTING EXCLUSIVE LOCK WITHIN ROUTE, AND STORAGE MEDIUM STORING INSTRUCTIONS TO PERFORM METHOD FOR SETTING EXCLUSIVE LOCK WITHIN ROUTE

(71) Applicant: SK TELECOM CO., LTD., Seoul (KR)

(72) Inventor: Jeongseok KIM, Seoul (KR)

(21) Appl. No.: 18/388,926

(22) Filed: Nov. 13, 2023

(51) Int. Cl. G08G 5/00; G08G 5/04

(52) U.S. Cl. CPC G08G 5/55; G08G 5/26; G08G 5/34; G08G 5/56; G08G 5/58; G08G 5/59; G08G 5/80

(57) ABSTRACT

There is provided a method of setting an exclusive lock within a route, performed by a route management device. The method comprises receiving, from a first advanced air mobility (AAM) moved within the route, a request for the exclusive lock for a first airspace segment among a plurality of airspace segments within the route; transmitting an exclusive lock request message for requesting the exclusive lock for the first airspace segment to a second AAM scheduled to enter into the first airspace segment; and receiving, from the second AAM, an exclusive lock approval message for approving the exclusive lock for the first airspace segment, and setting the exclusive lock in the first airspace segment.

### TECHNICAL FIELD

The present disclosure relates to a method and device for setting an exclusive lock in an airspace segment within a route.

This work is supported by Korea agency for infrastructure technology advancement (KAIA) grant funded by Korea government (MLIT; Ministry of land, infrastructure and transport) (No. 00143965, UAM Virtual Integrated Operation Platform (VIPP) Program).

### BACKGROUND

Advanced Air Mobility (AAM) is a next-generation mobility solution for maximizing travel efficiency in the city center and it emerged to solve the decline in travel efficiency due to congested traffic in the city center, a rapid increase in social costs such as logistics transportation costs, and the like. Now that long-distance travel times have increased and traffic congestion has become more severe, AAM is regarded as a future innovative business for solving these problems.

Since such AAMs are scheduled to be operated at low altitudes and at high density unlike existing AAMs, there may be cases where operating routes of multiple AAMs overlap within routes on which the AAMs operate.

In particular, in a case where an event such as an emergency or accident occurs inside or outside a air corridor during operation, and thus, an operation schedule which has already been agreed upon needs to be readjusted, the method therefor becomes an issue.

### SUMMARY

An object to be achieved by the present disclosure is to provide a method of setting an exclusive lock in an airspace segment within a route.

The objects to be accomplished by the present invention are not limited to the above object, and other objects that are not specified may be additionally considered within the scope that can be easily inferred from the following detailed description.

In accordance with an aspect of the present disclosure, there is provided a method of setting an exclusive lock within a route, performed by a route management device, the method comprises: receiving, from a first advanced air mobility (AAM) moved within the route, a request for the exclusive lock for a first airspace segment among a plurality of airspace segments within the route; transmitting an exclusive lock request message for requesting the exclusive lock for the first airspace segment to a second AAM scheduled to enter into the first airspace segment; and receiving, from the second AAM, an exclusive lock approval message for approving the exclusive lock for the first airspace segment, and setting the exclusive lock in the first airspace segment.

The method of setting the exclusive lock within the route may include setting the plurality of airspace segments within the route; and determining the first airspace segment among the plurality of airspace segments.

The transmitting of the exclusive lock request message may include identifying the second AAM scheduled to enter into the first airspace segment using pre-stored metadata for the first airspace segment.

The exclusive lock request message may include an identifier of the first AAM requesting the exclusive lock and a type of requesting the exclusive lock.

The type for requesting the exclusive lock includes at least one of occurrence of a passenger emergency situation in the first AAM, occurrence of an internal abnormal situation in the first AAM, occurrence of an external obstacle situation in the first airspace segment, occurrence of an external emergency situation in the first airspace segment, and occurrence of an overtaking restriction situation in the first airspace segment.

The method may include determining a second airspace segment to be set the exclusive lock with the first airspace segment on the basis of the metadata for the first airspace segment and the route of the first AAM. Also, the setting of the exclusive lock may include setting the exclusive lock for the first airspace segment and the second airspace segment.

The metadata may include information on airspace segments adjacent to the first airspace segment. Also, the determining of the second airspace segment may include checking an airspace segment included in the route of the first AAM among the airspace segments adjacent to the first airspace segment on the basis of the information on the airspace segments adjacent to the first airspace segment and the route of the first AAM, and determining the checked airspace segment as the second airspace segment.

The method may include receiving, from the second AAM, an exclusive lock rejection message for rejecting the exclusive lock for the first airspace segment, wherein the exclusive lock rejection message includes an identifier of the second AAM rejecting the exclusive lock and a type of rejecting the exclusive lock; comparing the type of requesting the exclusive lock with the type of rejecting the exclusive lock; and determining whether to set the exclusive lock for the first airspace segment according to the comparison result.

The type of rejecting the exclusive lock includes at least one of occurrence of a passenger emergency situation in the second AAM, occurrence of an internal abnormal situation in the second AAM, occurrence of an external obstacle situation in a second airspace segment in which the second AAM is moving, and occurrence of an external emergency situation in the second airspace segment.

In accordance with another aspect of the present disclosure, there is provided a method of setting an exclusive lock within a route, performed by a device mounted on an advanced air mobility (AAM), the method comprises: requesting the exclusive lock for a first airspace segment among a plurality of airspace segments within the route on the basis of a predetermined type of requesting the exclusive lock; and receiving an exclusive lock approval message for approving the exclusive lock for the first airspace segment, wherein the first airspace segment is an airspace segment through which AAMs other than the AAM are unable to pass for a predetermined period of time.

The requesting the exclusive lock for the first airspace segment includes setting the plurality of airspace segments within the route; and determining the first airspace segment among the plurality of airspace segments.

The requesting the exclusive lock for the first airspace segment may include determining a type of requesting the exclusive lock.

The type of requesting the exclusive lock includes at least one of occurrence of a passenger emergency situation in the AAM, occurrence of an internal abnormal situation in first airspace segment, occurrence of an external obstacle situation in the first airspace segment, occurrence of an external emergency situation in the first airspace segment, and occurrence of an overtaking restriction situation in the first airspace segment.

In accordance with another aspect of the present disclosure, there is provided a route management device, the device comprises: a transceiver configured to receive a request for the exclusive locking for a first airspace segment among a plurality of airspace segments within a route from a first AAM operating within the route; a memory storing one or more instructions; and a processor controlling the transceiver and executing the one or more instructions stored in the memory, wherein the instructions, when executed by the processor, cause the processor to transmit an exclusive lock request message for requesting the exclusive lock for the first airspace segment to a second AAM scheduled to enter into the first airspace segment using the transceiver; receive, from the second AAM, an exclusive lock approval message for approving the exclusive lock for the first airspace segment; and set the exclusive lock for the first airspace segment.

In accordance with another aspect of the present disclosure, there is provided a non-transitory computer-readable recording medium storing a computer program, which comprises instructions for a processor to perform a method of setting an exclusive lock within a route, the method comprise: receiving, from a first advanced air mobility (AAM) moved within the route, a request for the exclusive lock for a first airspace segment among a plurality of airspace segments within the route; transmitting an exclusive lock request message for requesting the exclusive lock for the first airspace segment to a second AAM scheduled to enter into the first airspace segment; and receiving, from the second AAM, an exclusive lock approval message for approving the exclusive lock for the first airspace segment, and setting the exclusive lock in the first airspace segment.

In accordance with another aspect of the present disclosure, there is provided a non-transitory computer-readable recording medium storing a computer program, which comprises instructions for a processor to perform a method of setting an exclusive lock within a route, the method comprise: requesting the exclusive lock for a first airspace segment among a plurality of airspace segments within the route on the basis of a predetermined type of requesting the exclusive lock; and receiving an exclusive lock approval message for approving the exclusive lock for the first airspace segment, wherein the first airspace segment is an airspace segment through which AAMs other than the AAM are unable to pass for a predetermined period of time.

According to an embodiment of the present disclosure, when an event such as an emergency situation or accident has occurred in an AAM, the event that has occurred in the AAM can be rapidly processed by setting an exclusive lock in airspace segments within a travel route.

According to an embodiment of the present disclosure, when an event such as an emergency situation or accident has occurred in an AAM, an operation schedule with respect to other AAMs can be rapidly readjusted by setting an exclusive lock in airspace segments within a travel route.

### BRIEF DESCRIPTION OF THE DRAWINGS

FIG. 1 is a block diagram showing an AAM operation system according to an embodiment.

FIG. 2 is a diagram illustrating an example of setting an exclusive lock in a predetermined airspace segment while a plurality of AAM is operating simultaneously.

FIG. 3 is a flowchart illustrating a method of setting an exclusive lock according to an embodiment.

FIG. 4 is a flowchart illustrating a method of rejecting an exclusive lock when the exclusive lock is requested according to an embodiment.

FIGS. 5A to 5C illustrate examples of recommending an alternative route to another AAM when an exclusive lock is set according to an embodiment.

FIG. 6 is a block diagram showing a device according to an embodiment.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

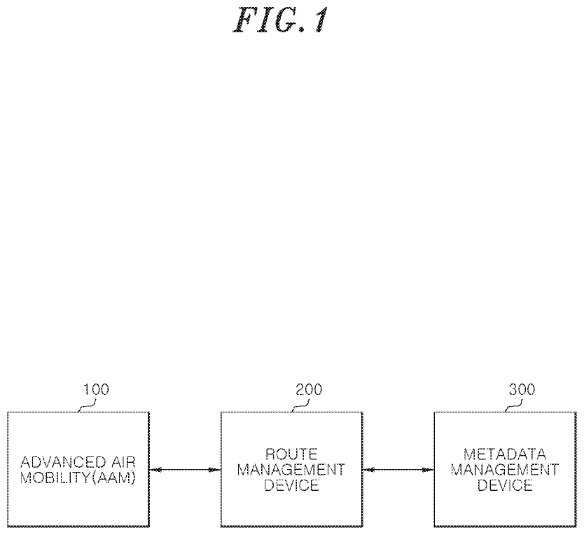

FIG. 1 is a block diagram showing an AAM operation system according to an embodiment.

Referring to FIG. 1, the AAM operation system 10 may include an AAM 100, a route management device 200, and a metadata management device 300.

The AAM 100 can travel from a departure point to a destination along a route.

The AAM 100 may request an exclusive lock for one of a plurality of airspace segments included in the route based on a type of requesting the exclusive lock.

Although the AAM 100 is described as executing functions according to the present disclosure for convenience of description in the present disclosure, it can be understood that the functions are executed by a device (e.g., an operation device) mounted on the AAM 100.

Additionally, in the present disclosure, the exclusive lock may mean that an AAM for which the exclusive lock has been approved monopolizes use/passage/operation in a predetermined airspace segment for a preset period of time.

To this end, the AAM 100 may transmit information on an operation route to the route management device 200 that manages (controls) operation routes.

According to the embodiment, the AAM 100 may include an advanced air mobility (AAM) vehicle and a drone.

The route management device 200 may divide a route into a plurality of airspace segments based on a predetermined standard and manage each of the plurality of divided airspace segments. In this case, the route may include at least one air corridor, and at least one air corridor may include at least one airspace segment.

Each air corridor may be formed in the shape of a cylinder, a cuboid, or a two-dimensional plane (including a three-dimensional plane at a very low height), and each of the plurality of airspace segments may be formed in the shape of a sphere or a cuboid (including a cube), but the present disclosure is not limited thereto.

According to the embodiment, the route management device 200 may divide each air corridor into a plurality of airspace segments based on the shape of each air corridor or a size of each air corridor. Also, according to the embodiment, when the route management device 200 divides each air corridor into a plurality of airspace segments, the route management device 200 may divide each air corridor into the plurality of airspace segments such that at least a part of each of the plurality of airspace segments overlaps with at least a part of at least one adjacent airspace segment.

Furthermore, the route management device 200 may divide airspace segments in various ways in order to efficiently manage information occurring on the route. For example, if the shape of the route is straight and the frequency of occurrence of events affecting navigation is predicted to be low, the route management device 200 may generate airspace segments around the vertiport. In this way, when operating to generate airspace segments around the vertiport, the AAM operation system 10 mainly manages the information generated during AAM takeoff and landing, and when in operation, the AAM operation system 10 checks the status of the route based on the information sent by AAM. As another example, when the route includes multiple inflection points, the route management device 200 may set a waypoint at the inflection points of the route and generate airspace segments around the vertiport and adjacent to the waypoint. As another example, when the route includes multiple inflection points and events affecting a movement of the AAM are expected in regions between waypoints, the route management device 200 may generate airspace segments not only in the area around the vertiport and the waypoint, but also in regions between waypoints in which events affecting the movement of the AAM are expected.

The shape and size of the generated airspace segments can be determined in various ways. For example, the shape of the airspace segments may be set in the form of a three-dimensional polyhedron or sphere by considering latitude, longitude, and altitude information. As another example, it may be set in the form of a 2D polygon or circle taking into account latitude and longitude.

In the embodiment of the present disclosure, it is exemplified that the route management device 200 sets the airspace segment, but the present disclosure is not limited to this and may be changed in various ways. For example, urban air traffic management service provider (UATMSP) sets the airspace segments, and the route management device 200 receives information about the airspace segments or information about the setting of the airspace segments from UATMSP, and set the airspace segments based on the received information.

Upon receiving a request for an exclusive lock for one of the plurality of airspace segments from the AAM 100, the route management device 200 may determine whether to set the exclusive lock for the corresponding airspace segment. The route management device 200 may transmit the determination result to at least one AAM related to the exclusive lock.

To this end, the route management device 200 may generate metadata for each of the plurality of airspace segments. According to the embodiment, the route management device 200 may update the metadata for each of the plurality of airspace segments periodically or aperiodically.

The metadata may include an identifier, location, size (volume), information on adjacent airspace segments, AAM information, and segment-of-interest information.

The identifier may mean a type of ID for distinguishing each of the plurality of airspace segments from other airspace segments.

The location is the location of each of the plurality of airspace segments and may be represented using longitude, latitude, altitude, and the like. For example, in a case where the plurality of airspace segments is formed in the shape of a sphere, the locations thereof may be represented as center points, and in a case where the plurality of airspace segments is formed in the shape of a cuboid, the location of each airspace segment may be represented as a center point which is the midpoint between a starting point corresponding to a vertex of the cuboid and an end point corresponding to a vertex located in a diagonal direction of the starting point.

The size is the size of each of the plurality of airspace segments, and it is represented as a radius in a case where the plurality of airspace segments is formed in the shape of a sphere and represented using the starting point and the end point in a case where the plurality of airspace segments is formed in the shape of a cuboid.

The information on adjacent airspace segments may include an identifier of each of at least one airspace segment adjacent to each of the plurality of airspace segments.

The AAM information may indicate information on an AAM located in each of the plurality of airspace segments at the time when the metadata is generated.

The segment-of-interest information may indicate information on objects such as an AAM, an external system, and the like that have set a corresponding airspace segment as a segment of interest.

The route management device 200 may transmit metadata for each of the plurality of airspace segments to the metadata management device 300 (or stores the same in the metadata management device 300), and if there is a request for the exclusive lock for a predetermined airspace segment from the AAM 100, receive (or load) metadata for the corresponding airspace segment from the metadata management device 300.

According to the embodiment, the route management device 200 may be a device (e.g., a device providing a discovery synchronization service (DSS)) managed by an urban air traffic management service provider (UATMSP) that controls (manages) routes for each route.

The metadata management device 300 may receive/store/manage metadata for each of the plurality of airspace segments generated by the route management device 200.

According to the embodiment, the metadata management device 300 may correspond to a database in which metadata for each of a plurality of airspace segments is stored.

Although the route management device 200 and the metadata management device 300 are described as separate devices for convenience of description in the present disclosure, the present disclosure is not limited thereto. That is, according to an embodiment, the route management device 200 and the metadata management device 300 may be implemented as detailed functions or storage included in one device (or system), and the metadata management device 300 may also be implemented as a storage included in the route management device 200.

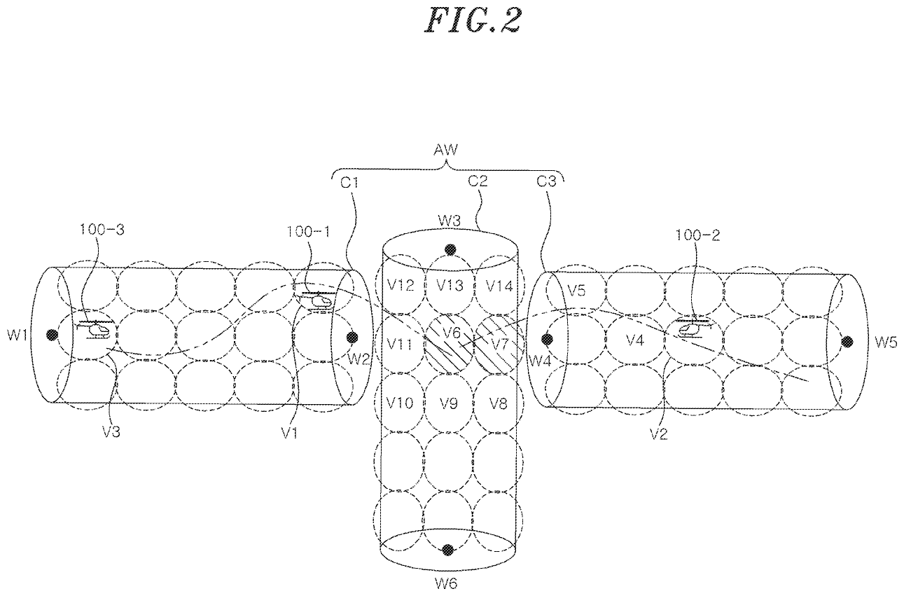

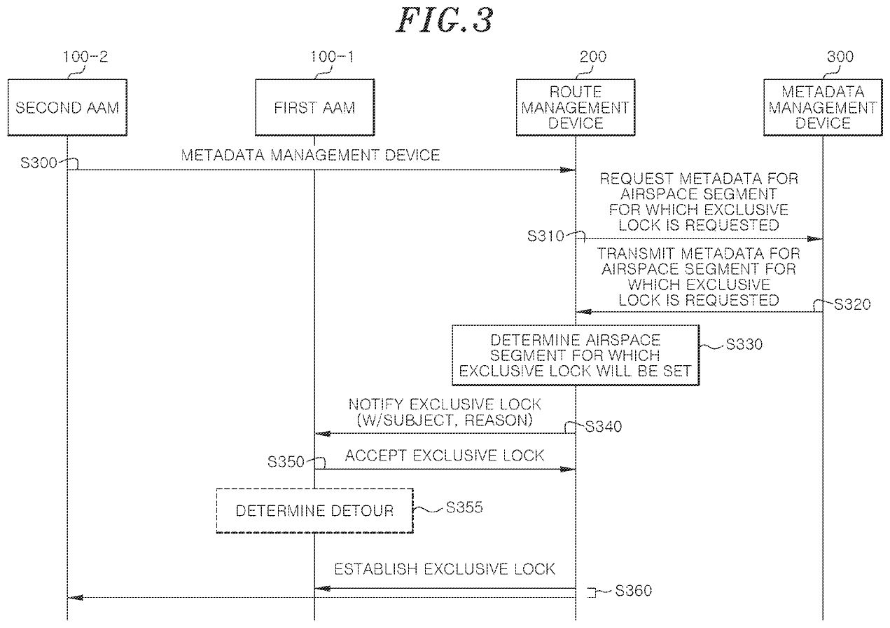

FIG. 2 is a diagram illustrating an example of setting an exclusive lock in a predetermined airspace segment while a plurality of AAMs is operating simultaneously, and FIG. 3 is a flowchart illustrating a method of setting the exclusive lock according to an embodiment.

Referring to FIGS. 1 and 2, a route AW may include a first air corridor C1, a second air corridor C2, and a third air corridor C3, the first air corridor C1 may be formed between a first midpoint W1 and a second midpoint W2, the second air corridor C2 may be formed between a third midpoint W3 and a sixth midpoint W6, and the third air corridor C3 may be formed between a fourth midpoint W4 and a fifth midpoint W5.

In this case, all of a first AAM 100-1, a second AAM 100-2, and a third AAM 100-3 may be traveling toward a destination (for example, a vertiport) located at the sixth midpoint W6, the first AAM 100-1 may be traveling in a first airspace segment V1 included in the first air corridor C1, the second AAM 100-2 may be traveling in a second airspace segment V2 included in the third air corridor C3, and the third AAM 100-3 may be traveling in a third airspace segment V3 included in the first air corridor C1.

All of the first AAM 100-1, the second AAM 100-2, and the third AAM 100-3 need to pass through the sixth airspace segment V6 to reach the destination corresponding to the sixth midpoint W6, and depending on remaining distances to the sixth airspace segment V6, the first AAM 100-1, the second AAM 100-2, and the third AAM 100-3 may pass through the sixth airspace segment V6 in that order.

Meanwhile, in FIG. 3, among the first AAM 100-1, the second AAM 100-2, and the third AAM 100-3 shown in FIG. 2, only the first AAM 100-1 and the second AAM 100-2 will be described.

Accordingly, further referring to FIG. 3, when the predetermined exclusive lock request conditions are satisfied for the second AAM 100-2, the second AAM 100-2 may send a request for the exclusive lock for the sixth airspace segment V6 to the route management device 200 (S300).

The above-described exclusive lock request conditions may include a case in which an emergency situation has occurred for a passenger of the second AAM 100-2. Also, the exclusive lock request conditions may include a case in which an internal abnormal situation in the second AAM 100-2 has occurred. For example, the internal abnormal situation may include a case in which the second AAM 100-2 needs to end the operation earlier than scheduled has occurred. Also, the exclusive lock request conditions may include a case in which an external obstacle situation in the second airspace segment V2 has occurred. For example, the external obstacle situation in the second airspace segment V2 may include a case in which the second AAM 100-2 needs to rapidly leave the second airspace segment V2 due to appearance of a flock of birds, turbulence, rainfall, strong wind, hail, and the like. Also, the exclusive lock request conditions may include a case in which an external emergency situation in the second airspace segment V2 has occurred. For example, external emergency situation may include a case in which at least one of a fire, exceeding an operating noise limit, or an abnormal situation of a general aircraft has occurred in at least one of airspace segments adjacent to the second airspace segment V2 and thus operation cannot be performed on the planned route. Also, the exclusive lock request conditions may include a case in which an overtaking restriction situation in the sixth airspace segment V6 has occurred. For example, the overtaking restriction situation may include a case in which a problem has occurred at the sixth midpoint W6 corresponding to the destination, and thus the first AAM 100-1 which is scheduled to land/arrive/pass before the second AAM 100-2 is unable to land/arrive/pass through.

According to an embodiment, when transmitting a request for the exclusive lock, the second AAM 100-2 may transmit, to the route management device 200, the identifier of the second AAM 100-2 requesting the exclusive lock and the reason for requesting the exclusive lock (i.e., conditions that are satisfied among the exclusive lock request conditions) along with the request.

Upon receiving the request for the exclusive lock from the second AAM 100-2, the route management device 200 may send a request for metadata for the sixth airspace segment V6 for which the exclusive lock is requested to the metadata management device 300 (S310), and the metadata management device 300 may transmit the metadata for the sixth airspace segment V6 to the route management device 200 in response to the request of the route management device 200 (S320).

Alternatively, according to an embodiment, if the metadata management device 300 corresponds to a database, the route management device 200 may load the metadata for the sixth airspace segment V6 for which the exclusive lock is requested from the metadata management device 300.

Subsequently, the route management device 200 may determine an associated airspace segment for which the exclusive lock will be set along with the sixth airspace segment V6 based on the metadata for the sixth airspace segment V6 received (or loaded) from the metadata management device 300 and the operating route of the second AAM 100-2 (S330).

More specifically, the route management device 200 may check that a seventh airspace segment V7, an eighth airspace segment V8, a ninth airspace segment V9, a tenth airspace segment V10, an eleventh airspace segment V11, a twelfth airspace segment V12, a thirteenth airspace segment V13, and a fourteenth airspace segment V14 are adjacent to the sixth airspace segment V6 using the metadata for the sixth airspace segment V6, and may check that the second AAM 100-2 will pass through the seventh airspace segment V7 among the airspace segments adjacent to the sixth airspace segment V6 using the operating route of the second AAM 100-2.

Accordingly, the route management device 200 may check the seventh airspace segment V7 through which the second AAM 100-2 will pass among the airspace segments adjacent to the sixth airspace segment V6 on the basis of the metadata for the sixth airspace segment V6 and the operating route of the second AAM 100-2, and determine the seventh airspace segment V7 as an associated airspace segment for the sixth airspace segment V6.

Thereafter, the route management device 200 may notify the first AAM 100-1 for which the sixth airspace segment V6 has been set as a segment of interest among the plurality of AAMs traveling on the route AW of the exclusive lock for the sixth airspace segment V6 (S340).

The segment of interest may be set by an AAM traveling on the route AW or an external system. For example, an AAM may set an airspace segment through which the AAM will pass during operation among the plurality of airspace segments included in the route AW as the segment of interest, and the external system may set an airspace segment that needs to be monitored among the plurality of airspace segments included in the route AW as the segment of interest.

According to an embodiment, in a case where a predetermined event (e.g., a request for the exclusive lock) has occurred in an airspace segment set as a segment of interest, an AAM or the external system may receive an alarm (e.g., a notification of the exclusive lock) with respect to the event that has occurred.

That is, the route management device 200 may confirm that the first AAM 100-1 has set the sixth airspace segment V6 as a segment of interest on the basis of the preset operating route of the first AAM 100-1 and notify the first AAM 100-1 of the exclusive lock for the sixth airspace segment V6.

According to the embodiment, when transmitting an exclusive lock notification to the first AAM 100-1, the route management device 200 may also transmit, to the first AAM 100-1, the identifier of the second AAM 100-2 as the subject requesting the exclusive lock and the type for requesting the exclusive lock.

If the first AAM 100-1 does not reject the exclusive lock of the second vehicle 100-2, the first AAM 100-1 may transmit a message for approving the exclusive lock of the second AAM 100-2 to the management device 200 (S350).

According to the embodiment, as the exclusive lock is set in the sixth airspace segment (V6), the first AAM 100-1 may travel to the destination (e.g., vertiport located at the sixth midpoint W6) through an airspace segment other than the sixth airspace segment V6, or determine to detour to a destination (a vertiport other than the vertiport located at the sixth midpoint W6) through the other airspace segment (S355).

Upon receiving approval for the exclusive lock from the first AAM 100-1, the route management device 200 may transmit a message indicating that an exclusive lock request has been set for the sixth airspace segment V6 to the second AAM 100-2 that has requested the exclusive lock for the sixth airspace segment V6 and the first AAM 100-1 that has set the sixth airspace segment V6 as a segment of interest (S360).

Other AAMs may not pass through the sixth airspace segment V6 and the seventh airspace segment V7 until the exclusive lock of the second AAM 100-2 is terminated (released).

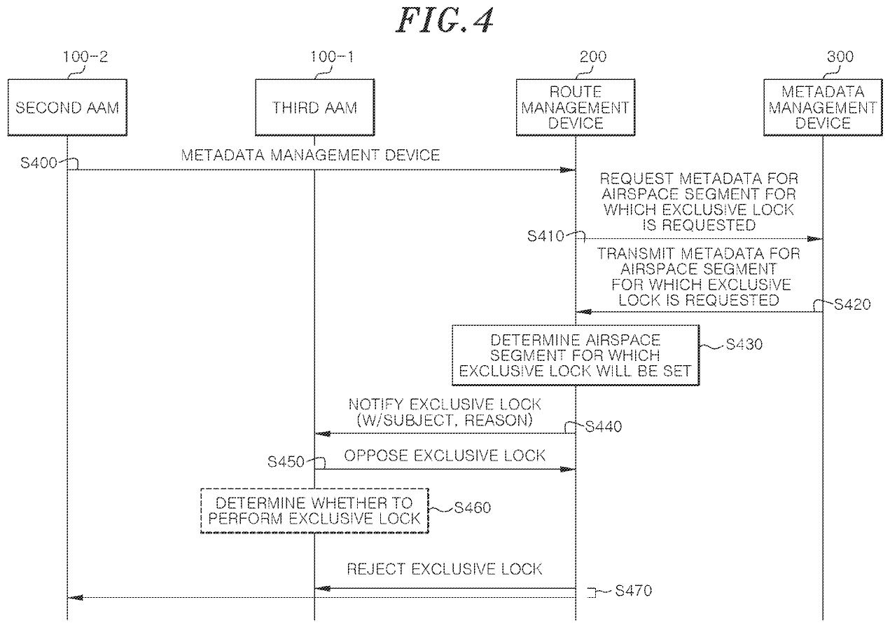

FIG. 4 is a flowchart illustrating a method of opposing exclusive lock when an exclusive lock is requested according to an embodiment.

In FIG. 4, only the second AAM 100-2 and the third AAM 100-3 will be described among the first AAM 100-1, the second AAM 100-2, and the third AAM 100-3 shown in FIG. 2.

Referring to FIGS. 1, 2, and 4, in a case where a predetermined exclusive lock request condition occurs in the second AAM 100-2, the second AAM 100-2 may send a request for exclusive lock for the sixth airspace segment V6 to the route management device 200 (S400).

Upon receiving a request for the exclusive lock from the second AAM 100-2, the route management device 200 may request metadata for the sixth airspace segment V6 to the metadata management device 300 (S410), and the metadata management device 300 may transmit the metadata for the sixth airspace segment V6 to the route management device 200 in response to the request of the route management device 200 (S420).

The route management device 200 may check the seventh airspace segment V7 through which the second AAM 100-2 will pass among airspace segments adjacent to the sixth airspace segment V6 on the basis of the metadata for the sixth airspace segment V6 received (or loaded) from the metadata management device 300 and the operating route of the second AAM 1002, and determine the seventh airspace segment V7 as an associated airspace segment for the sixth airspace segment V6 (S430).

Thereafter, the route management device 200 may confirm that the third AAM 100-3 has set the sixth airspace segment V6 as a segment of interest on the basis of the preset operating route of the third AAM 100-3, and notify the third AAM 100-3 of exclusive lock for the sixth airspace segment V6 (S440).

The third AAM 100-3 may determine whether to reject the exclusive lock for the sixth airspace segment V6 requested by the second AAM 100-2 on the basis of preset exclusive lock rejection conditions.

The above exclusive lock rejection conditions may include a case in which an emergency situation has occurred for a passenger of the third AAM 100-3. Also, the exclusive lock rejection conditions may include a case in which an internal abnormal situation in the third AAM 100-3 has occurred. For example, the internal abnormal situation may include a case in which an abnormal situation occurred in the third AAM 100-3 needs to end earlier than scheduled has occurred. Also, the exclusive lock rejection conditions may include a case in which an external obstacle situation in the third airspace segment V3 has occurred. For example, the external obstacle situation in the third airspace segment V3 may include a case in which the third AAM 100-3 needs to rapidly leave the third airspace segment V3 due to appearance of a flock of birds, turbulence, rainfall, strong wind, hail, and the like. Also, the exclusive lock rejection conditions may include a case in which an external emergency situation in the third airspace segment V3 has occurred. For example, external emergency situation may include a case in which at least one of a fire, exceeding an operating noise limit, or an abnormal situation of a general aircraft has occurred in at least one of airspace segments adjacent to the third airspace segment V3, and thus, operation cannot be performed on the planned route.

When exclusive lock rejection conditions are satisfied, the third AAM 100-3 may transmit a message for rejecting the exclusive lock for the sixth airspace segment V6 to the route management device 200 (S450).

According to the embodiment, when rejecting the exclusive lock, the third AAM 100-3 may also transmit the reason for rejecting the exclusive lock (i.e., a condition that is satisfied among the exclusive lock rejection conditions) to the route management device 200.

Upon receiving the message for rejecting the exclusive lock from the third AAM 100-3, the route management device 200 may compare the type for requesting the exclusive lock received from the second AAM 100-2 with the type for rejecting the exclusive lock received from the third AAM 100-3 and determine whether to perform the exclusive lock according to the comparison result (S460).

More specifically, a priority order may be preset for each of the type for requesting the exclusive lock and the type for rejecting the exclusive lock, and the route management device 200 may select the reason having a higher priority order between the type for requesting the exclusive lock received from the second AAM 100-2 and the type for rejecting the exclusive lock received from the third AAM 100-3.

For example, if the type for rejecting the exclusive lock received from the third AAM 100-3 has a higher priority order than type for requesting the exclusive lock received from the second AAM 100-2, the route management device 200 may determine not to accept the request for the exclusive lock from the second AAM 100-2 according to rejection of the third AAM 100-3. That is, the route management device 200 may determine not to set the exclusive lock for the sixth airspace segment V6.

Although the route management device 200 compares the type for requesting the exclusive lock received from the second AAM 100-2 with the type for rejecting the exclusive lock received from the third AAM 100-3 and determines whether to perform the exclusive lock according to the comparison result in the present disclosure for convenience of description, the present disclosure is not limited thereto. That is, according to an embodiment, a device or system other than the route management device 200 may compare the type for requesting the exclusive lock received from the second AAM 100-2 with the type for rejecting the exclusive lock received from the third AAM 100-3, determine whether to perform the exclusive lock according to the comparison result, and transmit the determination result to the route management device 200.

Upon determining to set the exclusive lock for the sixth airspace segment V6, the route management device 200 may transmit a message indicating that the exclusive lock request for the sixth airspace segment V6 has been accepted to the second AAM 100-2 that requested the exclusive lock for the sixth airspace segment V6 and the third AAM 100-3 that has set the sixth airspace segment V6 as a segment of interest (S470).

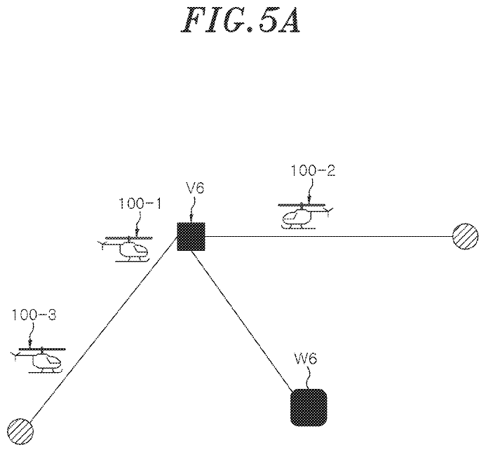

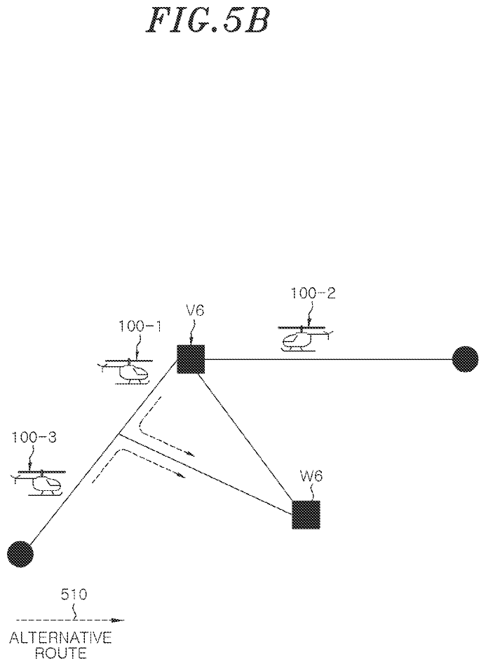

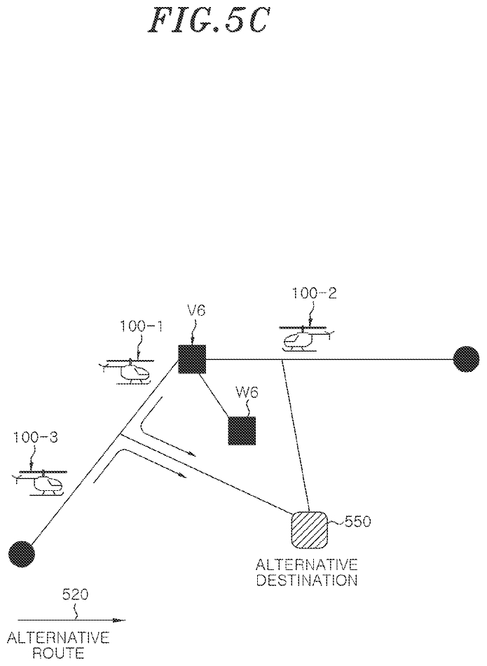

FIGS. 5A to 5C illustrate examples of recommending an alternative route to another AAM when the exclusive lock has been set according to an embodiment.

Referring to FIGS. 1 to 4 and FIG. 5A, when the second vehicle 100-2 requests the exclusive lock for the sixth airspace segment V6, the first AAM 100-1 and the third AAM 100-3 may not be able to pass through the sixth airspace segment V6 if the first AAM 100-1 and the third AAM 100-3 do not reject the exclusive lock for the sixth airspace segment V6 or if the exclusive lock for the sixth airspace segment V6 is approved by the route management device 200 even if there is rejection.

In such a case, the second AAM 100-2 that has requested the exclusive lock may recommend an alternative route that does not pass through the sixth airspace segment V6 to the first AAM 100-1 and the third AAM 100-3.

Foe example, referring to FIGS. 5B and 5C, the second AAM 100-2 may receive information on routes from the route management device 200 and recommend a first alternative route 510 to a destination (e.g., vertiport located at the sixth midpoint W6) without passing through the sixth airspace segment V6 or a second alternative route 520 to an alternative destination different from the destination (e.g., vertiport located at the sixth midpoint W6).

Although the second AAM 100-2 that has requested the exclusive lock recommends the alternative route in the present disclosure for convenience of description, the present disclosure is not limited thereto. That is, according to an embodiment, the route management device 200 or another system (e.g., a UATMSP system) may recommend an alternative route that does not pass through the sixth airspace segment V6 to the first AAM 100-1 and the third AAM 100-3.

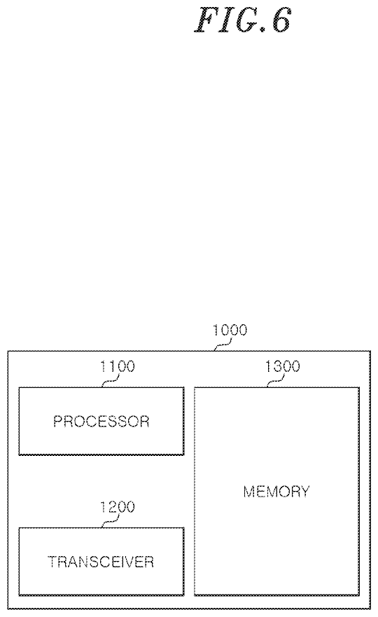

FIG. 6 is a block diagram showing a device according to an embodiment.

Referring to FIGS. 1 to 6, the device 1000 may be one of devices mounted on AAMs 100 (100-1, 100-2, and 100-3), the route management device 200, and the metadata management device 300.

The device 1000 may include a processor 1100, a transceiver 1200, and a memory 1300.

The processor 1100 may generally control the device 1000 to perform the functions, procedures, and/or methods of the device 1000 described herein.

The transceiver 1200 may transmit/receive data to/from other device by being controlled by the processor 1100.

The memory 1300 may store programs for performing the functions, procedures, and/or methods of the device 1000.

The processor 1100 may execute the programs stored in the memory 1300 to perform the functions, procedures, and/or methods described in the present disclosure.

According to an embodiment of the present disclosure, when an event such as an emergency situation or accident has occurred in an AAM, the event that has occurred in the AAM can be rapidly processed by setting the exclusive lock in airspace segments within an operating route.

According to an embodiment of the present disclosure, when an event such as an emergency situation or accident has occurred in an AAM, operation schedules with respect to other AAMs can be actively readjusted by setting the exclusive lock in airspace segments within an operating route.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method of setting an exclusive lock within a route, performed by a route management device, the method comprising:
receiving, from a first advanced air mobility (AAM) moved within the route, a request for the exclusive lock for a first airspace segment among a plurality of airspace segments within the route;
transmitting an exclusive lock request message for requesting the exclusive lock for the first airspace segment to a second AAM scheduled to enter into the first airspace segment; and
receiving, from the second AAM, an exclusive lock approval message for approving the exclusive lock for the first airspace segment, and setting the exclusive lock in the first airspace segment.

2. The method of claim 1, further comprising:
setting the plurality of airspace segments within the route; and
determining the first airspace segment among the plurality of airspace segments.

3. The method of claim 1, wherein the transmitting of the exclusive lock request message comprises identifying the second AAM scheduled to enter into the first airspace segment using pre-stored metadata for the first airspace segment.

4. The method of claim 1, wherein the exclusive lock request message includes an identifier of the first AAM requesting the exclusive lock and a type of requesting the exclusive lock.

5. The method of claim 4, wherein the type for requesting the exclusive lock includes at least one of:
occurrence of a passenger emergency situation in the first AAM,
occurrence of an internal abnormal situation in the first AAM,
occurrence of an external obstacle situation in the first airspace segment,
occurrence of an external emergency situation in the first airspace segment, and
occurrence of an overtaking restriction situation in the first airspace segment.

6. The method of claim 1, further comprising determining a second airspace segment to be set the exclusive lock with the first airspace segment on the basis of the metadata for the first airspace segment and the route of the first AAM,
wherein the setting of the exclusive lock includes setting the exclusive lock for the first airspace segment and the second airspace segment.

7. The method of claim 6, wherein the metadata includes information on airspace segments adjacent to the first airspace segment, and
wherein the determining of the second airspace segment includes checking an airspace segment included in the route of the first AAM among the airspace segments adjacent to the first airspace segment on the basis of the information on the airspace segments adjacent to the first airspace segment and the route of the first AAM, and determining the checked airspace segment as the second airspace segment.

8. The method of claim 4, further comprising:
receiving, from the second AAM, an exclusive lock rejection message for rejecting the the exclusive lock for the first airspace segment, wherein the exclusive lock rejection message includes an identifier of the second AAM rejecting the exclusive lock and a type of rejecting the exclusive lock;
comparing the type of requesting the exclusive lock with the type of rejecting the exclusive lock; and
determining whether to set the exclusive lock for the first airspace segment according to the comparison result.

9. The method of claim 8, wherein the type of rejecting the exclusive lock includes at least one of:
occurrence of a passenger emergency situation in the second AAM,
occurrence of an internal abnormal situation in the second AAM,
occurrence of an external obstacle situation in a second airspace segment in which the second AAM is moving, and
occurrence of an external emergency situation in the second airspace segment.

10. A method of setting an exclusive lock within a route, performed by a device mounted on an advanced air mobility (AAM), the method comprising:
requesting the exclusive lock for a first airspace segment among a plurality of airspace segments within the route on the basis of a predetermined type of requesting the exclusive lock; and
receiving an exclusive lock approval message for approving the exclusive lock for the first airspace segment,
wherein the first airspace segment is an airspace segment through which AAMs other than the AAM are unable to pass for a predetermined period of time.

11. The method of claim 10, wherein the requesting the exclusive lock for the first airspace segment includes:
setting the plurality of airspace segments within the route; and
determining the first airspace segment among the plurality of airspace segments.

12. The method of claim 10, wherein the requesting the exclusive lock for the first airspace segment includes determining a type of requesting the exclusive lock.

13. The method of claim 12, wherein the type of requesting the exclusive lock includes at least one of:
occurrence of emergency situation in the AAM,
occurrence of an internal abnormal situation in first airspace segment,
occurrence of an external obstacle situation in the first airspace segment,
occurrence of an external emergency situation in the first airspace segment, and
occurrence of an overtaking restriction situation in the first airspace segment.

14. A route management device comprising:
a transceiver configured to receive a request for an exclusive locking for a first airspace segment among a plurality of airspace segments within a route from a first AAM operating within the route;
a memory storing one or more instructions; and
a processor controlling the transceiver and executing the one or more instructions stored in the memory, wherein the instructions, when executed by the processor, cause the processor to,
transmit an exclusive lock request message for requesting the exclusive lock for the first airspace segment to a second AAM scheduled to enter into the first airspace segment using the transceiver;
receive, from the second AAM, an exclusive lock approval message for approving the exclusive lock for the first airspace segment; and
set the exclusive lock for the first airspace segment.

15. The route management device of claim 14, wherein the processor is configured to set the plurality of airspace segments within the route; and determine the first airspace segment among the plurality of airspace segments.
